(19) United States
(12) Patent Application Publication
(10) Pub. No.: US 2019/0076869 A1
(43) Pub. Date: Mar. 14, 2019

(54) METHOD FOR OPERATING A SURFACE TREATMENT INSTALLATION AND DEVICE FOR SEPARATING OUT OVERSPRAY

(71) Applicant: EISENMANN SE, Böblingen (DE)

(72) Inventors: Georg Fröhlich, Overderdingen (DE); Jürgen Röckle, Magstadt (DE)

(21) Appl. No.: 15/999,356

(22) PCT Filed: Jan. 25, 2017
(86) PCT No.: PCT/EP2017/051540

§ 371 Date: Aug. 17, 2018

(30) Foreign Application Priority Data
Feb. 17, 2016 (DE) 10 2016 001 888.7

(51) Int. Cl. B05B 14/43; B01D 46/00; B01D 50/00

(52) U.S. Cl. CPC B05B 14/437; B01D 46/0015; C09D 7/71; B01D 46/008; B01D 50/006; B01D 46/0027

(57) ABSTRACT

A method for operating a surface treatment installation wherein overspray that occurs in one or more coating booths is taken up by a booth air stream. Booth air laden with overspray is conducted to at least one separating unit in which overspray is separated out. The booth air laden with overspray or the booth air free of overspray is fed a solidifying material on its flow path to at least one separating unit and/or the booth air laden with overspray or the booth air free of overspray is fed a solidifying material in the interior of at least one separating unit and/or overspray that has already been deposited in at least one separating unit is fed a solidifying material and/or the at least one separating unit is fed a solidifying material before the separating unit is functionally fitted in the surface treatment installation, wherein the solidifying material has the effect that a curing process in the overspray is initiated or assisted. A device for separating out overspray from the booth air laden with overspray of surface treatment installations. Booth air laden with overspray can be passed through at least one separating unit, in which overspray is deposited. There is a solidifying material feeding device, by means of which the booth air laden with overspray can be fed a solidifying material on its flow path to at least one separating unit and/or the booth air laden with overspray can be fed a solidifying material in the interior of at least one separating unit and/or overspray that has already been deposited in at least one separating unit can be fed a solidifying material, wherein the solidifying material has the effect that a curing process in the overspray is initiated or assisted.

The invention relates to a method for operating a surface treatment installation, in which overspray which arises in one or more coating booths is absorbed by a booth air stream and in which overspray-laden booth air is guided to at least one separating unit in which overspray is separated out.

The invention also relates to a device for separating overspray out of the overspray-laden booth air of surface treatment installations, in particular of painting installations, having at least one separating unit through which overspray-laden booth air is able to be guided and in which overspray is separated out.

In the manual or automatic application of paints to objects, a partial stream of the paint, which generally contains both solids and/or binding agents and solvents, is not applied to the object. Said partial stream is referred to among experts as “overspray”. Furthermore, the terms “overspray” and “overspray particle” are always to be understood within the context of a disperse system, such as an emulsion or suspension system or a combination thereof. The overspray is captured by the air stream in the painting booth and fed to a separating system so that the air, possibly after suitable conditioning, can be guided back into the coating booth.

In particular in installations with relatively high paint consumption, for example in installations for painting vehicle bodies, use is preferably made in a known way of, on the one hand, wet separators, on the other hand, of electrostatically operating dry separators. In known wet separators, a relatively large amount of energy is needed for circulating the rather large quantities of water required. The treatment of the rinsing water is costly owing to the high level of use of chemicals which bind and de-tack paint and owing to the disposal of paint sludge. Furthermore, as a result of intensive contact with the rinsing water, the air absorbs a very large amount of moisture, which in turn results in high energy consumption for the air treatment during air recirculation operation.

As an alternative to widely-used stationary wet and dry separating systems, which can also operate electrostatically, use is also made of systems with replaceable disposable separating units which, after a limit loading with overspray has been reached, are replaced by unladen separating units and disposed of or, if appropriate, recycled. The treatment and/or disposal of such separating units can be more acceptable in terms of energy and also in view of the necessary resources than the outlay in the case of a wet separator or an electrostatically operating separating device.

Such a method and such a device using disposable separating units are known for example from DE 10 2013 011 107 A1.

In electrostatically operating dry separators, the paint overspray has to be continually removed from the separation surfaces, this normally being associated with rather complex measures in terms of construction.

Generally, overspray has highly adhesive properties and normally has liquid constituents. Consequently, in the case of stationary separating units, in particular in the case of electrostatically operating separating units, it is in some cases difficult to remove and handle the separated overspray.

In the case of disposable separating units, in particular the liquid constituents of the overspray can accumulate on the bottom of a separating unit, which, during disposal or further utilization, makes their handling more difficult. In particular, care must then be taken that the separating units are not tilted since the accumulated liquid constituents could otherwise escape.

It is an object of the invention to provide a method and a device of the type mentioned at the beginning which reduce these disadvantages.

Said object is achieved in a method of the type mentioned at the beginning in that
a) a solidifying material is fed to the overspray-laden booth air or the overspray-free booth air on its flow path to at least one separating unit;
and/or
b) a solidifying material is fed to the overspray-laden booth air or the overspray-free booth air in the inner space of at least one separating unit;
and/or
c) a solidifying material is fed to overspray which has already been deposited in at least one separating unit;
and/or
d) solidifying material is fed to the at least one separating unit before the separating unit is functionally fitted in the surface treatment installation;
wherein
e) the solidifying material causes a curing process for the overspray to be triggered or supported.

The invention is based on the realization that, through the addition of a solidifying material, which may even be a substance mixture, a curing process for the overspray can be triggered or supported in the separating unit, with the result that solidified paint is present in the separating unit at least in comparison with the initial consistency. The curing process results in the overspray being transferred from a free-flowing state into a state with a higher viscosity, in which it is then present in the separating unit. In such a state, the overspray is for example pasty or solid.

The solidifying material should react with the overspray in the separating unit while the separating unit is in operation in the surface treatment installation and, for this purpose, is functionally fitted in the surface treatment installation. This is possible by way of the above-mentioned alternatives.

When the solidifying material is fed to the booth air, it is possible on the one hand for the solidifying material to be fed to the booth air during a surface treatment which gives rise to overspray with which the booth air is then laden. The solidifying material can be fed to the overspray-laden booth air on the path to the separating unit or in the interior of the separating unit, wherein the “interior of a separating unit” is intended to define the position at which the separation of the overspray is realized. This does not mean that a housing assigned to the separating unit has to be present.

On the other hand, the solidifying material may also be fed to the booth air if no surface treatment is carried out, provided that the booth air stream is maintained. The solidifying material can then be fed to the then overspray-free booth air likewise on the path to the separating unit or in the interior of the separating unit.

The solidifying material may firstly pass into the separating unit at the same time as the overspray if the addition of solidifying material is initiated at the same time overspray arises. Alternatively, the addition of solidifying material may also be initiated only when a specific quantity of overspray has already been deposited in the separating unit.

Alternatively or additionally, the solidifying material may also already be fed to a separating unit before the latter is functionally fitted in the surface treatment installation. In this case, the separating unit is, as it were, impregnated with solidifying material in a step which precedes the use of said unit in the installation.

This is particularly favorable if, as a separating unit, use is made of a disposable separating unit in which overspray is separated out and which, as a laden disposable separating unit, is replaced by an empty disposable separating unit after a limit loading with overspray has been reached. In particular, after their limit loading has boon reached, it is possible for such disposable separating units to be handled in a considerably simpler manner if the paint deposited therein has already substantially or completely hardened than is the case with disposable separating units in which liquid overspray is still present.

Alternatively, it may be advantageous if, as a separating unit, use is made of a partly disposable separating unit in which overspray is separated out and from which individual components are replaced after a limit loading with overspray has been reached. For example, a separating unit may comprise a housing which is fixed in the surface treatment installation, and one laden filter unit of the separating unit is replaced only.

Moreover, as a result of the curing process, it is possible for specific paints which are classified as hazardous substances to lose their status as a hazardous substance, or to be categorized in a hazardous substance class with a lower hazard potential, where appropriate with the result that a disposable separating unit which is to be disposed of and is filled with overspray is subjected to less restrictive conditions of transportation and is easier to handle. This correspondingly applies to paint which is to be disposed of and which comes from separating units which are not designed as disposable separating units.

It is advantageous if solidifying material is added in an amount of 0.1 to 15% by weight, preferably of 1 to 10% by weight, particularly preferably of 5% by weight, in relation to the limit loading of the disposable separating unit. This is based on the pure, undiluted solidifying agent. Consequently, the maximum absorption capacity of the separating unit for overspray is influenced only in a scarcely noticeable manner by the solidifying material.

Curing processes may be chemically- or physically-based depending on the paint to be cured. It is advantageous in particular if use is made of a solidifying material which reacts with the overspray in a chemical and/or chemical-catalytic manner and/or causes curing of the overspray by way of physical and/or rheological effects.

In order to select a suitable solidifying material, the paint type of the paint which is to be cured must be known.

Paints can be classified according to different aspects. For example, paints can be subdivided according to their function in the case of multicoat paints, for example as primers, surfacers and topcoats. Another or additional subdivision may occur on the basis of the number of components, for example 1-component paints, 2-component paint, or according to the solvent contained and the amount thereof, for example solvent-based paints, water-based paints, so-called high-solid paints or powder-based paints.

However, these divisions by themselves do not give sufficient information about the manner in which the solidification of the paint is realized. In order to be able to divide the paints into paint families according to the aspects of solidification, further classifications have to be selected. One starting point is for example a division according to the type of film former, for example a division into amino resin paints, for example melamine resin paints, acrylate resin paints, polyurethane paints or epoxy resin paints, which in each case define a particular crosslinking and thus solidification of the paint. If the type of the film former and its reaction mechanism are known, it is possible to select a solidifying material with which solidification can be triggered, supported or, if appropriate, accelerated. A classification according to the processing conditions, for example with regard to baked paints and oxidatively curing or radiation-curing paints, here also provides an important indication of the solidification principles.

As examples of solidifying materials, use may in particular be made of: sulfonic acids, in particular p-toluenesulfonic acid, dodecylbenzenesulfonic acid, dinonylnaphthalenedisulfonic acid and dinonylnaphthalenesulfonic acid, and the salts and esters of sulfonic acids (sulfonates); phosphoric acids, in particular: phosphoric(V) acid, phenylphosphoric acid, butylphosphoric acid and dibutylphosphoric acid and the salts and esters thereof (phosphonates), dicarboxylic acids and the salts and esters thereof, in particular maleic acid and maleic acid monobutyl ester; fumed silica; amines, in particular triethylenediamine (TEDA); organotin compounds, in particular dioctyltin dilaurate, dibutyltin dilaurate; bismuth carboxylates, in particular bismuth trioctoate and bismuth trisneodecanoate; bismuth-tin carboxylates; organic peroxides, in particular benzoyl peroxide and 2-butanone peroxide; saturated water vapor.

For a melamine resin paint, good results can be obtained for example with a solidifying material which is based on phosphoric acid and p-toluenesulfonic acid.

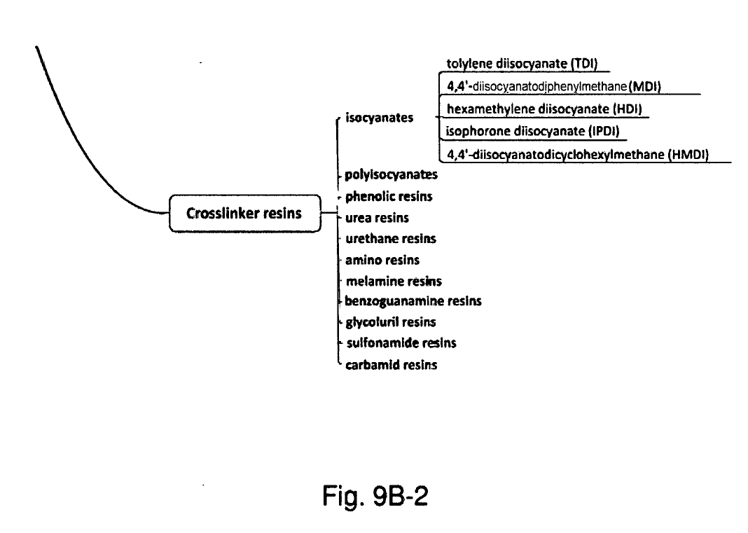

FIGS. 9A and 9B show these examples and further examples of solidifying materials, wherein a subdivision of the solidifying materials according to chemical effect in “Catalysts”, “Polymerization reaction initiators” and “Crosslinker resins” and according to rheological effect in “Rheological additives” is used.

Furthermore, it is also possible for other suitable solidifying materials to be found in the literature. Paolo Nanetti, Lackrohstoffkunde [Study of raw materials for paint], 4^{th} Edition, Hanover, Vincentz Network, 2012, in particular pages 159-187, and T. Brock, M. Groteklaes, P. Mischkc, B. Strehmel, Lehrbuch der Lacktechnologie [Textbook of paint technology], 4^{th} Edition, Hanover, Vincentz Network, 2012, in particular pages 192-205 may be cited as examples.

As mentioned above, the solidifying material may also be a mixture of individual components of said components and comprises one or more components which are selected from catalysts, polymerization reaction initiators, rheological additives and/or crosslinker resins, as are specified in FIGS. 9A and 9B.

The solidifying material may be used both in pure form and in solution. It is thus possible, for example, for the solidifying material to be dissolved in water or organic solvents prior to its use. This allows the solidifying material to be conveyed more easily to the dispensing location in the installation in certain cases and/or better mixing with the overspray to be achieved.

In a device of the type mentioned at the beginning, the object specified above is achieved with the same advantages in that
a) a solidifying-material feed device is provided, by means of which
   aa) a solidifying material is able to be guided to the overspray-laden booth air on its flow path to at least one separating unit;
   and/or
   ab) a solidifying material is able to be fed to the overspray-laden booth air in the inner space of at least one separating unit;
   and/or
   ac) a solidifying material is able to be fed to overspray which has already been deposited in at least one separating
wherein
b) the solidifying material causes a curing process for the overspray to be triggered or supported.

For the device too, it is correspondingly advantageous if the separating unit is a disposable separating unit in which overspray is separated out and which, as a laden disposable separating unit, is able to be replaced by an empty disposable separating unit after a limit loading with overspray has been reached.

If the solidifying material is liquid and, in particular, is able to be sprayed or nebulized, it is favorable if the solidifying-material feed device comprises nozzles via which solidifying material is able to be fed.

Both in the case of liquid solidifying material and in the case of solid solidifying material it may be advantageous if the solidifying-material feed device comprises a dosing device by means of which it is possible to produce a solidifying-material curtain through which the overspray-laden booth air is able to flow on its flow path.

In one advantageous modification, the solidifying-material feed device comprises a supporting device for a solidifying-material material body. The booth air can then flow against or around such a material body, wherein the entrained overspray comes into contact with the solidifying material of which the material body is composed or which the latter comprises.

Exemplary embodiments of the invention will be discussed in more detail below on the basis of the drawings, in which:

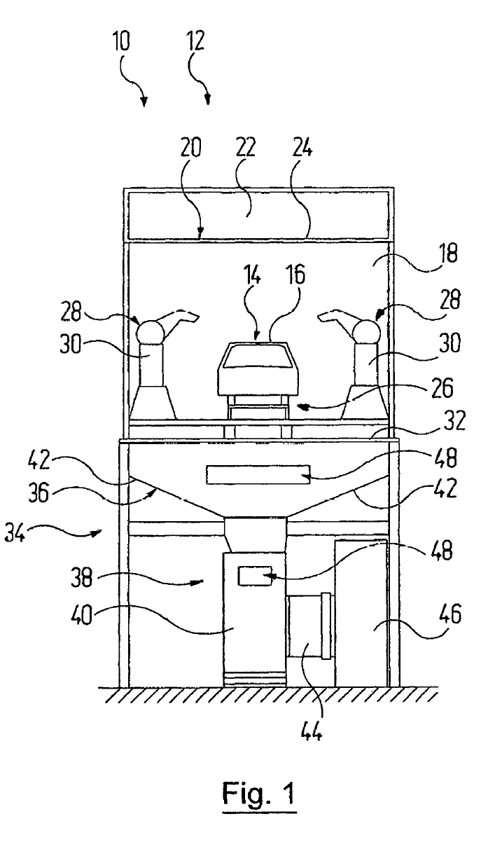

FIG. 1 shows, in a front view, a painting booth having a separating device for overspray, in which booth there is provided a solidifying-material feed device by way of which a solidifying material is fed to the overspray-laden booth air on its flow path to separating units and/or to the overspray-laden booth air within separating units and/or to the overspray which has already been deposited in separating units;

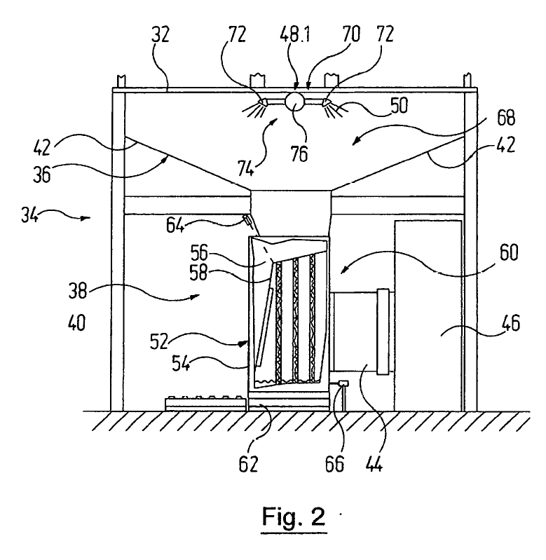

FIGS. 2-8 show seven exemplary embodiments of a solidifying-material feed device, wherein separating units of the separating device are modules;

FIGS. 9A and 9B show an overview of examples of components of solidifying material.

In FIG. 1, the reference sign 10 denotes, as a whole, a coating booth of a surface treatment installation 12, in which objects 14 are painted. Vehicle bodies 16 are shown as an example of objects 14 to be painted. Before these reach such a coating booth 10, they have been cleaned and degreased, for example, in pretreatment stations (not specifically shown).

Afterwards, the vehicle bodies 16 are provided in a manner known per se with a primer, a basecoat and a topcoat in successive coating stations. Arranged in each of these coating stations is a coating booth 10 in which the respective coating material is applied to the vehicle body 16.

In each coating booth 10 of the different treatment stations, different types of overspray arise, that is to say, expressed generally, the surface treatment installation 12 comprises multiple coating booths 10 in which different types of overspray arise.

A coating booth 10 has a coating tunnel 18, arranged at the top, with a ceiling 20 which is formed in a conventional manner as a lower delimitation of an air-feeding space 22 having a filter ceiling 24.

The vehicle bodies 16 are transported from the entry side of the coating tunnel 18 to the exit side thereof by way of a conveying system 26 which is accommodated in the coating tunnel 18 and which is known per se. Situated in the interior of the coating tunnel 18 are application devices 28, which are shown here by way of example as multi-axle application robots 30, as are likewise known per se.

By means of the application robots 30, the vehicle bodies 16 can be coated with the corresponding coating material.

In the downward direction, the coating tunnel 18 is open via a grating 32, which can be walked upon, toward an installation region 34 which is arranged below said grating and in which overspray particles entrained by the booth air are separated from the booth air.

During the coating process, air flows downward from the air-feeding space 22 to the installation region 40 through the coating tunnel 18, wherein the air absorbs overspray paint which is present in the coating tunnel 18 and entrains it.

This overspray-laden air is guided with the aid of an air-guiding device 36 to multiple separating units 38 of a separating device 40, in which units paint overspray is separated from the booth air. In the present exemplary embodiments, the separating units 38 are arranged one behind the other in the longitudinal direction of the coating booth 10, and for this reason only one such separating unit can be seen in FIG. 1. The separating units 40 may be designed as reusable separating units, for example as electrostatically operating separating units or other regenerative separating units, or as disposable separating units. When a limit loading is reached, disposable separating units are replaced in their entirety by an empty disposable separating unit and are treated, or disposed of, together with the absorbed overspray. Alternatively, the separating units may also be designed as partly disposable separating units, in the case of which, after the limit loading has been reached, only individual components are replaced, as mentioned at the beginning.

The air-guiding device 36 comprises air-guiding plates 42, which at least partially delimit the flow path of the booth air and guide the latter to the separating units 38. During operation, each separating unit 38 is connected to the air-guiding device 36 in terms of flow and, in particular in the case of disposable separating units, in a releasable manner.

After the booth air has flowed through a separating unit 38, the booth air, which has then been substantially freed of overspray particles, passes into an intermediate channel 44 and, from there, into a collecting flow channel 46. The booth air is fed to a further treatment and conditioning system via the collecting flow channel 46 and, subsequent to this, is guided back into the air-feeding space 22 in a circuit (not specifically shown here), from which space said air again flows into the coating tunnel 18 from above.

In case the booth air has still not been sufficiently freed of overspray particles by the separating units 38 which are present, it is possible for even more filtering stages, to which the booth air is fed, to be arranged downstream of the separating units.

The coating booth 10 comprises a solidifying-material feed device 48 by way of which a solidifying material 50 can be fed to the overspray-laden booth air on its flow path to separating units 38 and/or to the overspray-laden booth air within separating units 38 and/or to the overspray which has already been deposited in separating units 38, which solidifying material is identified only in FIGS. 2 to 8. In FIG. 1, the solidifying-material feed device 48 is indicated merely highly schematically in the region of the air-guiding device 36 and in the region of the separating unit 38.

The solidifying material 50 causes a curing process with the overspray entrained by the booth air to be triggered or supported. The curing process results in the overspray being transferred from a free-flowing state into a state with a higher viscosity, in which it is then present in the separating unit 38. In this way, the overspray paint, or, in the case of disposable separating units, the disposable overspray-laden separating unit, can be transported, and also treated or disposed of, more easily than would be possible without the prior curing of the overspray.

Here, the curing process does not have to lead to the complete curing of the overspray paint, but complete curing of the overspray can be realized.

The solidifying material 50 is generally a material mixture composed of different components. However, the solidifying material 50 may also be a single material. Possible components of the solidifying material 50 have already been discussed above, also with reference to FIGS. 9A and 9B.

Quite generally and for all the exemplary embodiments specifically discussed below, when the solidifying material is added, what matters in particular is good mixing with the overspray. The better the materials involved are mixed, the quicker and more complete the curing of the overspray is in general. The addition of the solidifying material may at all times be realized either continuously, or in intervals in individual batches. If the solidifying material is liquid, it is possible for the addition to be realized by spraying or atomizing to form aerosol, by injecting, by introducing mist, by pouring, by introducing drops or instillation or the like.

If the solidifying material 50 is a solid, it may for example be sprinkled in or dusted, or introduced as pellets or the like, for example by way of a conveying screw, into the flow path of the overspray-laden booth air. A “solid” is also to be understood here to mean that a liquid solidifying material 50 has been absorbed by a solids support material.

A gaseous solidifying material 50 is for example injected.

If appropriate, it is also possible for a separating unit 38, prior to its use, to be prepared, and, as it were, impregnated with a liquid or solid solidifying material 50, such that overspray comes into contact with solidifying material 50 directly after the separation, as a result of which the curing process is initiated or supported.

In practice, solidifying material is added in an amount of 2 to 10% by weight, preferably of 2 to 8% by weight, particularly preferably of 5% by weight, in relation to an end loading of a separating unit 38. An “end loading of a separating unit” is to be understood to mean the loading with overspray in which a measure has to be carried out to remove the overspray in order that the separating device 40 remains operational.

In FIGS. 2 to 8, show in each case only the lower installation region 34 of the coating booth 10 and different exemplary embodiments of a solidifying-material feed device 48, which are denoted there by 48.1 to 48.7.

Also in FIGS. 2 to 8, disposable separating units 52 in the form of disposable filter modules 54 are shown as a separating unit 38, and for this reason firstly the disposable filter modules 54 and their use during operation are discussed. For the sake of simplicity, the disposable filter modules 54 are in this case referred to only as a filter module 54.

Each filter module 54 may be formed in a manner known per se for example as a separating filter or as an inertial filter or also as a combination thereof.

In a filter module 54, the booth air flows through an inner space 56 and a filter unit 58 which is accommodated there and at which the paint overspray is separated out. A housing wall of the filter module 54 is shown partially broken away such that it is possible to see into the inner space 48. Overall, each disposable separating unit 52 is formed as a replaceable structural unit.

The filter module 54 is locked in its operating position by means of a locking device (not specifically shown). In the present exemplary embodiments, the filter module 54 may be connected in terms of flow to the air-guiding device 36, or released therefrom, by being moved in a horizontal direction.

Generally, however, the coupling and decoupling movement depends on the interaction of the components and may also have vertical components of movement.

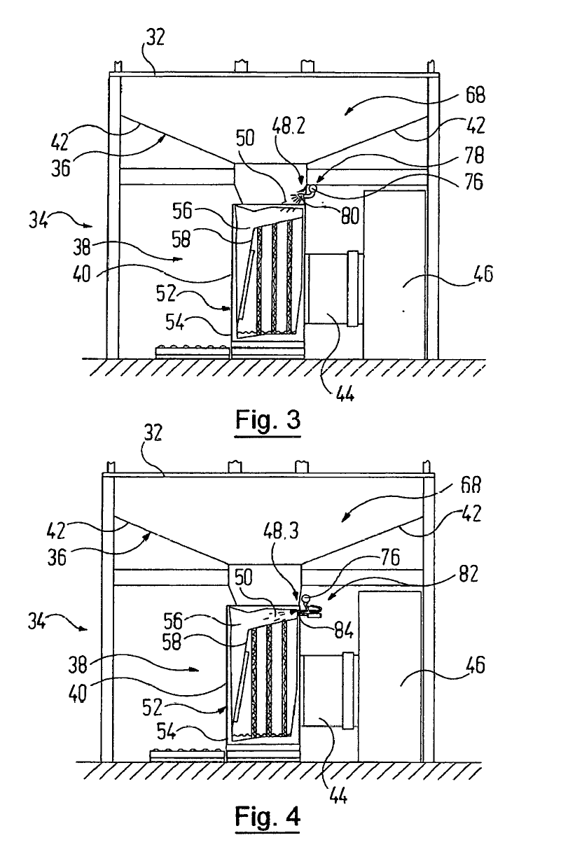

Each filter module 54 is designed for absorbing a maximum quantity of paint, that is to say for a limit loading with overspray, which depends on the design of the filter module 54 and the materials used therefor. The quantity of paint already absorbed can be monitored via a measurement device 60. FIG. 2 shows, as supplementary or alternative components of such a measurement device 60, on the one hand a scale 62 and on the other hand measurement sensors 64 and 66. The measurement device 60 is not specifically shown or identified in FIGS. 3 to 8.

The limit loading of a filter module 54 is thus the end loading of the separating unit, as was discussed above in connection with the quantities in which the solidifying material 50 is added.

With the aid of the scale 62, the loading of the filter module 54 is determined on the basis of its weight. The measurement sensor 64 may be for example a coat-thickness measurement sensor, by which the thickness of the paint coat building up on the filter unit 58, which forms during the separation of the overspray, can be detected. From the thickness of this coat, conclusions can in turn be drawn about the loading quantity of the filter module 54. The measurement sensor 66 can be for example a measurement sensor for moisture, temperature or pressure. In the last-mentioned case in particular, it is possible for the presence of the limit loading to be detected by means of a differential pressure determination. The greater the loading of the filter module 54, the greater the air resistance built up by the filter module 54.

When a filter module 54 reaches its maximum absorption capacity, the locking device is released and the fully loaded filter module 54 is moved out from the lower installation region 34 of the coating booth 10.

Overall, the replacement of one or more disposable filter modules 54 can be realized in a fully automatic or at least semi-automatic manner. Alternatively, such a replacement can also be realized for example with the aid of a lifting truck (not specifically shown) or the like, which is operated by a worker. For this purpose, the bottom region of the filter module 54 may be formed in terms of its geometry and its dimensions as a standardized bearing structure and for example according to the specification of a so-called Euro pallet.

Beforehand, the flow connection of the filter module 54 to be replaced to the air-guiding device 36 is closed off by means of shut-off valves (not specifically shown). After the full filter module 54 has been removed, an empty filter module 54 is pushed into the operating position, in which it is connected to the air-guiding device 36 in a sealed manner in terms of flow, whereupon the locking device is locked again. The shut-off valve of the air-guiding device 36 is brought into an open position again, with the result that the booth air flows through the newly positioned filter module 54.

Overall, the disposable filter module 54, including its filter unit 58, may be produced from a water-resistant recycled material.

Expressed generally, it is possible for one component, multiple components or all the components of the filter module 54 to be produced from a water-resistant recycled material. For this purpose, use may be made for example of cellulose materials, such as possibly treated paper and board materials, corrugated cardboard, cardboards with standing corrugations, cardboards with a honeycomb structure or wrapping cardboards, but also other materials, such as for example MDF materials. The bottom region of the filter module 54 may also be formed separately by a Euro pallet composed of wood. Use may also be made of plastics, such as in particular polyethylene or polypropylene.

Here, the filter module 54 itself may be delivered as a modular construction kit in individual parts and assembled at the location of the surface treatment installation 12. For example, it is possible for a filter module 54 to also be designed such that it can be unfolded from a folded-together configuration. A filter module construction kit has a volume which can be considerably smaller than the volume of the unfolded or constructed disposable filter modules 54.

As mentioned at the beginning, liquid constituents of the overspray can accumulate on the bottom of the filter modules 54, which, during further utilization, makes the handling thereof more difficult. In particular, care must then be taken that the filter modules 54 are not tilted since the accumulated liquid constituents could otherwise escape.

In order to prevent this, the coating booth 10 comprises the above-mentioned solidifying-material feed device 48.

With the solidifying-material feed device 48.1 shown in FIG. 2, the solidifying material 50 is fed to the overspray-laden booth air in a feed region 68 upstream of the separating units 38, that is to say upstream of the filter modules 54 in the present exemplary embodiment.

In the present exemplary embodiments, the feed region 68 upstream of the separating units 38 is the region of the flow path of the booth air between the coating tunnel 18 and the separating units 38. However, if appropriate, the solidifying material 50 may also be fed to the booth air in the coating tunnel 18, for example in a region below the vehicle bodies 16.

The solidifying-material feed device 48.1 comprises a flow-path nozzle arrangement 70 which is positioned in the flow path of the overspray-laden booth air. In the exemplary embodiment shown, the flow-path nozzle arrangement 70 comprises multiple dispensing elements in the form of nozzles 72 which are arranged one behind the other in the longitudinal direction of the coating booth 10 so as to be arranged just below the grating 32.

Two nozzles 72 are always arranged as a nozzle pair 74 such that solidifying material 50 is dispensed from the middle to both sides into the feed region 68. By way of the nozzles 72, it is possible for a solidifying material 50 which is able to be atomized or nebulized to be dispensed into the feed region 68.

The nozzles 72 are supplied via a supply tube 76 with solidifying material 50 which, for its part, is fed from a solidifying material source (not specifically shown). For the sake of clarity, conveying components, such as pumps, lines and control devices or the like, for the solidifying material 50 are not specifically shown.

The solidifying material 50 is introduced in the flow direction of the booth air. In one modification, the solidifying material 50 can also be introduced into the feed region 68 in the direction counter to the flow direction of the overspray-laden booth air.

The overspray-laden booth air absorbs the solidifying material 50 which is introduced into the feed region 70, said material triggering the above-mentioned curing process for the overspray which is entrained by the booth air.

In the exemplary embodiment shown in FIG. 3, the solidifying-material feed device 48.2 there comprises a lateral nozzle arrangement 78 by means of which solidifying material 50 is able to be introduced into the feed region 68 from the side. The lateral nozzle arrangement 78 comprises multiple dispensing elements in the form of side nozzles 80 which are arranged one behind the other in the longitudinal direction of the coating booth 10 just above the separating units 38 and, again, are fed from a supply tube 76. As a modification to the exemplary embodiment shown, it is possible for side nozzles 80 to also be arranged in each case on both sides of a separating unit 38.

In order that the side nozzles 80 projecting into the flow path of the overspray-laden booth air are not gummed up, a nozzle protector, which in the simplest form can be formed as a protection plate, is situated above the side nozzles 80.

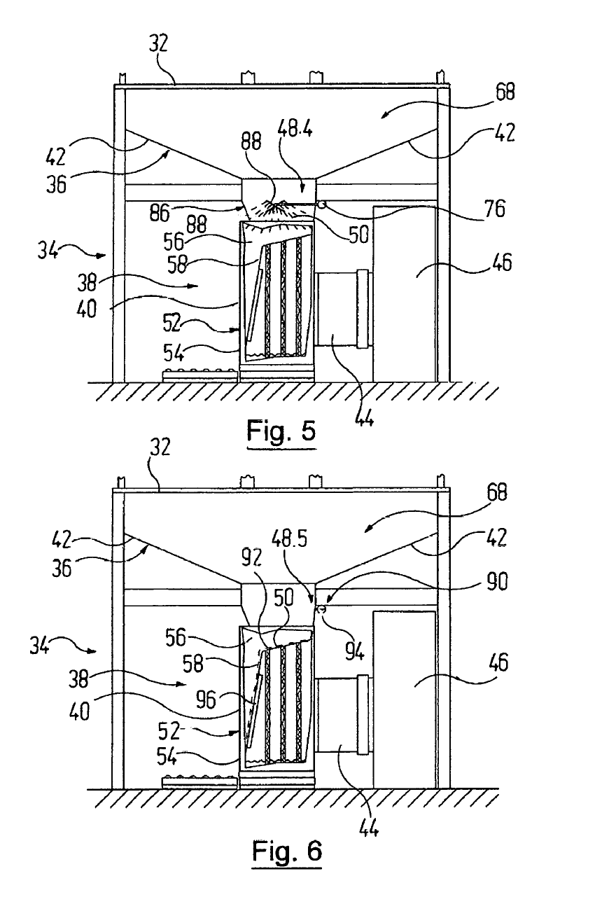

FIG. 4 shows, as a further exemplary embodiment, a solidifying-material feed device 48.3 by means of which the solidifying material 50 can be fed to the overspray-laden booth air within the separating units 38. There, the solidifying-material feed device 48.3 comprises a piercing mechanism 82 which is assigned to the provided separating units 38 and with the aid of which a nozzle 84 can be pierced through the wall of the separating unit 38 in order to thus introduce the solidifying material into the interior of the separating unit 38. Such a piercing mechanism 82 is indicated in particular if the solidifying material 50 is intended to be brought into contact with the overspray only shortly before or after the limit loading of a filter module 54 has been reached. In one modification, the separating unit 38 may already be provided with a possibly small opening through which a corresponding nozzle can be at least partially pushed by an insertion mechanism.

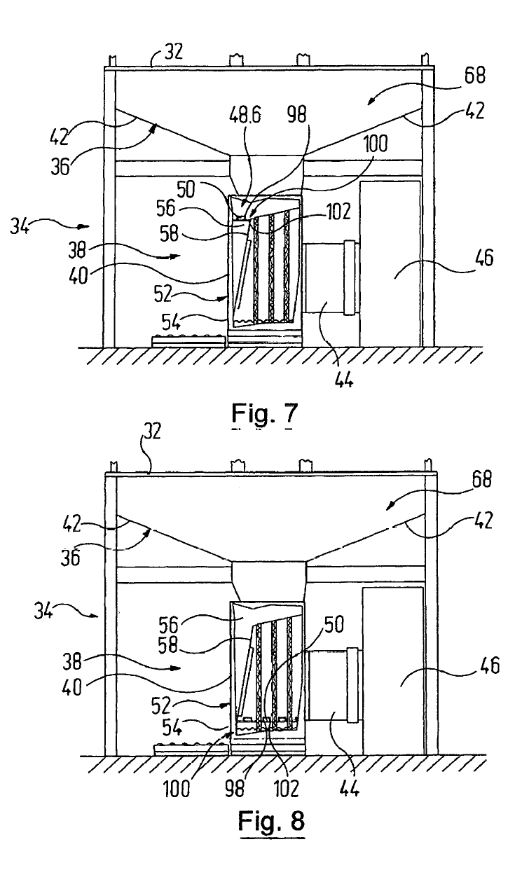

In the solidifying-material feed device 48.4 shown in FIG. 5, a spray tube arrangement 86 having tubular nozzles 88 which are formed as spray tubes and which are again fed from a supply tube 76 is provided in the feed region 68. In the exemplary embodiment shown, the tubular nozzles 88 are arranged in the form of a cross above a separating unit 38, with other arrangements likewise being possible however.

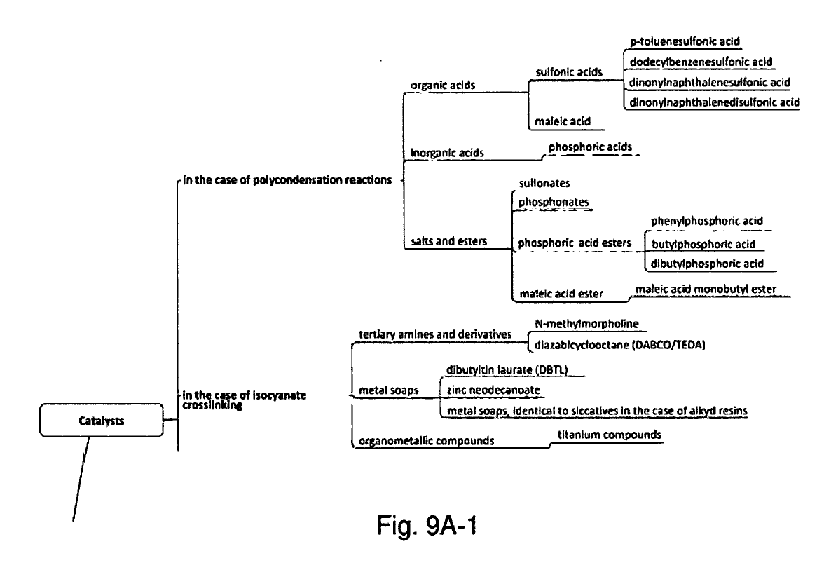

The solidifying-material feed device 48.5 as per FIG. 6 comprises a dosing device 90 by means of which it is possible to produce a solidifying-material curtain 92 through which the overspray-laden booth air flows on its flow path. The solidifying-material curtain 92 can be an at least substantially continuous curtain, in particular if the solidifying material 50 is liquid. For this purpose, the dosing device 90 may comprise for example a dispensing tube 94 having a slot opening, or alternatively an overflow channel over whose edge the liquid solidifying material continuously flows. If the solidifying material 50 is solid, it is possible for example for a screw conveyor to be used in an overflow channel in order to continuously dispense the solidifying material 50.

In the present exemplary embodiment, the solidifying-material curtain 92 is produced on the filter unit 58 of the filter module 54 in such a way that it flows over an inlet window 96, identified only in FIG. 6, of the filter unit 58, through which window the booth air enters the filter unit 58.

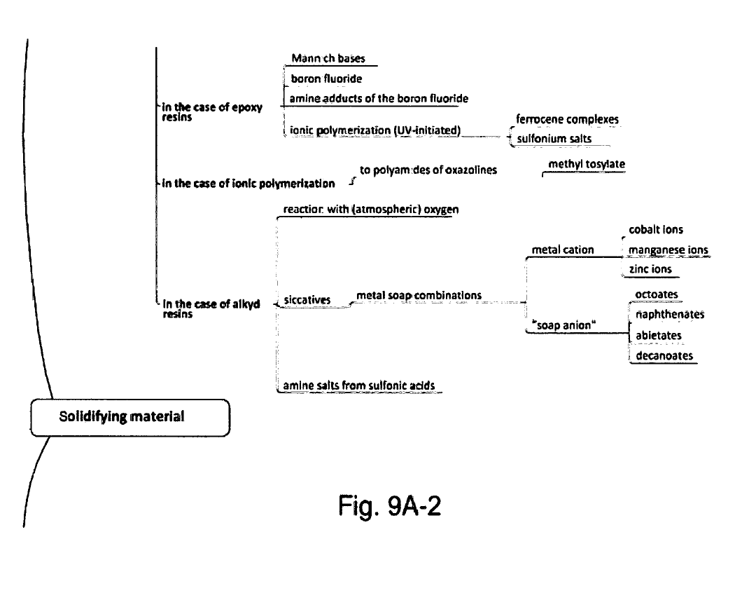

FIG. 7 shows, as a further exemplary embodiment, a solidifying-material feed device 48.6, in the case of which the solidifying material 50 is formed as a material body 98 which is supported by a supporting device 100 such that it is able to be flowed against in the flow path of the booth air. For example, the material body 98 rests on a supporting grating 102 in the inner space 56 of the filter module 54 and is reached by the overspray-laden booth air before the latter flows into the filter unit 58.

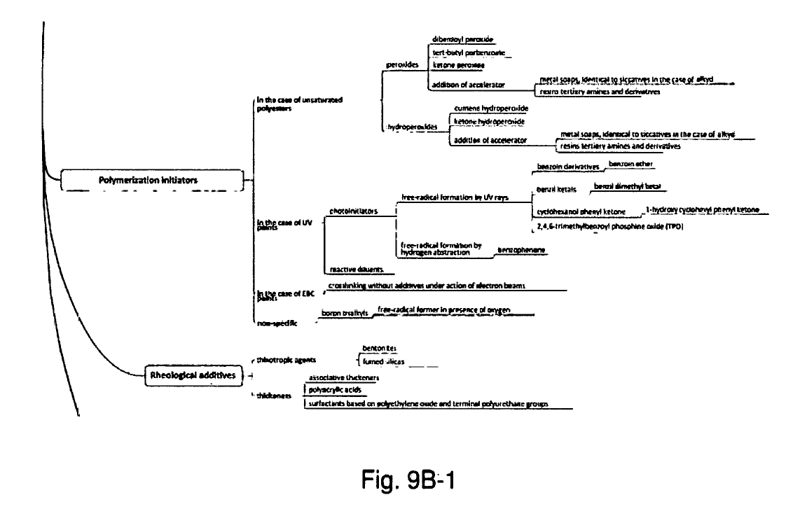

By contrast, in the modification shown in FIG. 8, multiple material bodies 96 composed of solidifying material 50 are situated on supporting gratings 102, of which in each case only one bears a reference sign, above the bottom region of the filter module 54, with the result that separated overspray flowing to the bottom comes into contact with the material bodies 96 on its path and then, mixed with solidifying material 50, passes into the bottom region of the filter module 54, where the curing process then takes place.

In one modification (not specifically shown), it is also possible for a funnel to be arranged in the flow path of the booth air, the inner wall of which funnel bears a spiral such that the funnel is formed as a screw funnel. Solid solidifying material can be fed to such a screw funnel, whereupon the screw funnel is vibrated by a vibrating device. In this way, the vibration pulses are transferred to the solidifying material which is thus conveyed along the spiral in an upward direction and drops into the separating unit over the edge of the screw funnel in the downward direction.

In one modification (likewise not specifically shown), the filter modules 54 can stand on a vibration plate. Solidifying material 50 and paint overspray are then mixed in an effective manner in the bottom region of the filter module 54 with the vibration plate active. If the filter module 54 is arranged on a vibration plate, it is possible for solidifying material 50 in powder form to be applied on or in a sieve which is fitted in the inner space 56 of the filter module 54, for example approximately in the position of the supporting grating 102 in FIG. 7. As a result of the vibration movement, the solidifying material 50 in powder form is introduced into the inner space 56 of the filter module 54 through the sieve.

In further modifications (not specifically shown), it is possible for irradiation devices and/or temperature-control devices to be provided in addition to the solidifying-material feed devices 48. A photoreaction can be initiated or supported with the aid of irradiation devices if radiation-curable overspray is involved. In this case, either the stream of the booth air can pass through a radiation window, or overspray is irradiated which has already been deposited in the separating unit 38 and also already mixed with solidifying material 50.

With a temperature-control device, it is firstly possible for solvent to be discharged from the overspray in a supportive manner. Secondly, a curing reaction takes place quicker at higher temperatures, and so a temperature rise effectively supports and accelerates the solidification of the overspray.

A temperature-control device is preferably used at the separating unit 38, where the temperature of the overspray which has already been deposited and mixed with solidifying material 50 is controlled.

What is claimed is:

1. A method for operating a surface treatment installation, the method comprising the steps of:
absorbing overspray which arises in one or more coating booths in a booth air stream;
guiding overspray-laden booth air to at least one separating unit in which overspray is separated out,
wherein
a) a solidifying material is fed to the overspray-laden booth air or overspray-free booth air on its flow path to the at least one separating unit; and/or
b) a solidifying material is fed to the overspray-laden booth air or the overspray-free booth air in an inner space of the at least one separating unit; and/or
c) a solidifying material is fed to the overspray which has already been deposited in the at least one separating unit;
and/or
d) a solidifying material is fed to the at least one separating unit before the at least one separating unit is functionally fitted in a surface treatment installation;
wherein
e) the solidifying material causes a curing process for the overspray to be triggered or supported.

2. The method as claimed in claim 1, wherein the at least one is separating unit a disposable separating unit in which overspray is separated out and which, as a laden disposable separating unit, is replaced by an empty disposable separating unit after a limit loading with overspray has been reached.

3. The method as claimed in claim 1, the at least one separating unit is a partly disposable separating unit in which overspray is separated out and from which individual components are replaced after a limit loading with overspray has been reached.

4. The method as claimed in claim 1, wherein the solidifying material is added in an amount of 0.1 to 15% by weight in relation to an end loading of the at least one separating unit.

5. The method as claimed in claim 1, wherein the solidifying material reacts with the overspray in a chemical and/or chemical-catalytic manner and/or causes curing of the overspray by way of physical and/or rheological effects.

6. The method as claimed in claim 1, wherein the solidifying material comprises one or more components which are selected from catalysts, polymerization reaction initiators, rheological additives and/or crosslinker resins.

7. A device for separating overspray out of the overspray-laden booth air of surface treatment installations comprising:
at least one separating unit through which overspray-laden booth air is able to be guided and in which overspray is separated out;
wherein
a) a solidifying-material feed device is provided, by means of which
aa) a solidifying material is able to be guided to the overspray-laden booth air on its flow path to at least one separating unit;
and/or
ab) a solidifying material is able to be fed to the overspray-laden booth air in an inner space of at least one separating unit;
and/or
ac) a solidifying material is able to be fed to overspray which has already been deposited in at least one separating unit;
wherein
b) the solidifying material causes a curing process for the overspray to be triggered or supported.

8. The device as claimed in claim 7, wherein the at least one separating unit is a disposable separating unit in which overspray is separated out and which, as a laden disposable separating unit, is able to be replaced by an empty disposable separating unit after a limit loading with overspray has been reached.

9. The device as claimed in claim 7, wherein the at least one separating unit is a partly disposable separating unit in which overspray is separated out and from which individual components are replaced after a limit loading with overspray has been reached.

10. The device as claimed in claim 7, wherein the solidifying-material feed device comprises nozzles via which solidifying material is able to be fed.

11. The device as claimed claim 7, wherein the solidifying-material feed device comprises a dosing device by means of which it is possible to produce a solidifying-material curtain through which the overspray-laden booth air is able to flow on its flow path.

12. The device as claimed in claim 7, wherein the solidifying-material feed device comprises a supporting device for a solidifying-material material body.

13. The method as claimed in claim 1, wherein the solidifying material is added in an amount of 1 to 10% by weight in relation to an end loading of the at least one separating unit.

14. The method as claimed in claim 1, wherein the solidifying material is added in an amount of 5% by weight, in relation to an end loading of the at least one separating unit.
